(19) United States
(12) Patent Application Publication
(10) Pub. No.: US 2025/0291838 A1
(43) Pub. Date: Sep. 18, 2025

(54) SYSTEM AND METHOD FOR A CATALOG OF TRAINING CONTENT AUGMENTED WITH ARTIFICIAL INTELLIGENCE

(71) Applicant: HSI USA Holding, Inc., Frisco, TX (US)

(72) Inventors: Jose Manuel William Arcilla, McKinney, TX (US); Michael Alan Case, Kennewick, WA (US); John William Hambelton, Eugene, OR (US)

(21) Appl. No.: 19/077,678

(22) Filed: Mar. 12, 2025

Related U.S. Application Data
(60) Provisional application No. 63/564,294, filed on Mar. 12, 2024.
(60) Provisional application No. 63/564,784, filed on Mar. 13, 2024.
(60) Provisional application No. 63/565,901, filed on Mar. 15, 2024.
(60) Provisional application No. 63/566,640, filed on Mar. 18, 2024.
(60) Provisional application No. 63/663,994, filed on Jun. 25, 2024.
(60) Provisional application No. 63/663,991, filed on Jun. 25, 2024.
(60) Provisional application No. 63/663,999, filed on Jun. 25, 2024.
(60) Provisional application No. 63/664,004, filed on Jun. 25, 2024.

(51) Int. Cl. G06F 16/41; G06F 16/438; G06F 40/295

(52) U.S. Cl. CPC G06F 16/41; G06F 16/438; G06F 40/295

(57) ABSTRACT

Systems, methods, and computer-readable storage media for indexing a catalog of training content, and more specifically to indexing the catalog of training content using Artificial Intelligence (AI) to improve responses to queries. A system can execute a search of training course content stored in a database, identifying at least one of new training course content or updated training course content. Based on the media type of the each piece of content, the system can execute one or more data extraction algorithms, resulting in extracted data for each piece of new or updated content. The system can then add the extracted data to a semantic search index.

### CROSS-REFERENCE TO RELATED APPLICATIONS

The instant application is a U.S. Non-Provisional Application that claims priority to U.S. Provisional Application No. 63/564,294 filed Mar. 12, 2024, U.S. Provisional Application No. 63/564,784 filed Mar. 13, 2024, U.S. Provisional Application No. 63/565,901 filed Mar. 15, 2024, U.S. Provisional Application No. 63/566,640 filed Mar. 18, 2024, U.S. Provisional Application No. 63/663,994 filed Jun. 25, 2024, U.S. Provisional Application No. 63/663,991filed Jun. 25, 2024, U.S. Provisional Application No. 63/663,999 filed Jun. 25, 2024 and U.S. Provisional Application No. 63/664,004 filed Jun. 25, 2024, the entire contents of each of which are hereby incorporated by reference in their entireties. The present application is related to co-pending U.S. Application Ser. No. ______ Attorney Docket No. 131637.607935, filed Mar. 12, 2025, U.S. Application Ser. No. ______, Attorney Docket No. 131637.607978, filed Mar. 12, 2025, and U.S. Application Ser. No. ______, Attorney Docket No. 131637.605724, filed Mar. 12, 2025, the entire contents of each of which are hereby incorporated by reference in their entireties.

### BACKGROUND

### 1. Technical Field

The present disclosure relates to indexing a catalog of training content, and more specifically to indexing the catalog of training content using Artificial Intelligence (AI) to improve responses to queries.

### 2. Introduction

Modern online training can be a combination of video, audio, slides, and/or text and searching that content remains a challenge.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: executing, at a computer system via at least one processor, a search of training course content stored in a database, the search identifying at least one of new training course content and updated training course content, resulting in search result content; identifying, via the at least one processor for each piece of content in the search result content, a media type of the each piece of content; executing, via the at least one processor on the each piece of content, at least one data extraction algorithm, wherein the at least one data extraction algorithm is based on the media type, resulting in extracted data for each piece of content in the search result content; and adding, via the at least processor, the extracted data to a semantic search index.

A system configured to perform the concepts disclosed herein can include: at least one processor; and a non-transitory computer-readable storage medium having instructions stored which, when executed by the at least one processor, cause the at least one processor to perform operations comprising: executing a search of training course content stored in a database, the search identifying at least one of new training course content and updated training course content, resulting in search result content; identifying, for each piece of content in the search result content, a media type of the each piece of content; executing, on the each piece of content, at least one data extraction algorithm, wherein the at least one data extraction algorithm is based on the media type, resulting in extracted data for each piece of content in the search result content; and adding the extracted data to a semantic search index.

A non-transitory computer-readable storage medium configured as disclosed herein can have instructions stored which, when executed by at least one processor, cause the at least one processor to perform operations which include: executing a search of training course content stored in a database, the search identifying at least one of new training course content and updated training course content, resulting in search result content; identifying, for each piece of content in the search result content, a media type of the each piece of content; executing, on the each piece of content, at least one data extraction algorithm, wherein the at least one data extraction algorithm is based on the media type, resulting in extracted data for each piece of content in the search result content; and adding the extracted data to a semantic search index.

### BRIEF DESCRIPTION OF THE DRAWINGS

FIG. 1 illustrates an example of course catalog AI index processing;

FIG. 2 illustrates an example of a catalog search;

FIG. 3 illustrates an example of course source file extraction and parsing;

FIG. 4 illustrates an example method embodiment; and

FIG. 5 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure.

Modern online training can be a combination of video, audio, slides, and/or text. In a traditional online training catalog, there will be many courses of different types and formats on differing topics. These courses are typically organized such that a user can search through these courses by aspects such as title, keywords, and/or length. However, this limited searching capacity means that even with access to full course previews a potential learner or training administrator may need to consume most of the course before they know they have made the correct choice. Moreover, maintaining these catalogs is equally difficult as courses undergo constant change requiring updated descriptions, titles, and changed content meaning.

Systems configured as disclosed herein can use AI to process each course stored in a catalog of courses in its entirety. The AI model and supporting processes disclosed herein can be used to extend the available material for stored courses through a series of steps including (but not limited to) generating a transcript, translating the course (e.g., video, slides, handouts, or other materials) into multiple languages, and/or creating quiz or exam questions. The AI process can identify keywords, phrases, industry terms, and named entities generated directly from source content (including, for example: course text, video closed captions, images, image alt text, learning objectives, regulatory references, human-generated course metadata, and course structure), all of which can be used in future searches, enabling users to have much more meaningful search results compared to only searching by title, human-generated keywords, etc. This AI-produced metadata can then be used to update an online training catalog, resulting in a much more effective tool in identifying desired training, casing the burden of catalog maintenance (e.g., humans no longer have to generate the metadata), and providing alternative paths to achieving learning objectives (e.g., by identifying alternative training content that satisfies the objectives, but which would not have been recognized were it not for the AI-produced metadata). Because the AI-produced metadata is generated via a scheduled workflow (e.g., upon upload of new training materials, or on a periodic schedule), new courses and course updates can be represented in the most effective way possible.

While the AI models and algorithms used herein can be any form of computer-executed algorithm that can perform tasks that typically require human intelligence, the AI models and algorithms referred to herein are neural networks trained specifically to absorb learning data and improve over time based on its experience in a manner similar to the way the human brain's neurons connect. Preferably, these AI models and algorithms represent a form of Limited Memory AI, which use a combination of the pre-programmed course data, previous, question history, and other recent activity data (such as incident reports or training performance). The system can also have a constant monitoring log, which holds the feedback, confidence scores, and other weighting factors, and constantly observes drift from established baselines to ensure responses are accurate.

In addition, systems configured as disclosed herein can make use of natural language querying. The combination of natural language query and AI indexing can allow for natural language responses as part of the results. For example, search results can provide answers to the query and references to the online course content the answer was extracted from. This allows the learner or training administrator to gain knowledge from a trusted source, understand the course on a much deeper level, and still have access to traditional search results.

At a high level, the system disclosed herein receives content, determines the type of content received (e.g., by a marker, data, or other identifier which identifies the type of content, by a file type, or through an analysis to determine which type of program will run a given file). In some configurations, addition to looking at the file extension, the AI model can determine file type by looking at underlying data stream. The system can then analyze that content using AI, with the system performing key phrase extraction and metadata generation. For example, the AI model can be provided definitions and examples of key phrases and structures such as learning objectives, regulations and citations, and other relevant phrases which are then indexed in the vector database which powers the AI model. The AI model can then and normalize the results such that the content (or a specific portion thereof) can be identified through future natural language searches made by users. Rather than replacing any and all previously generated metadata, the AI-generated metadata acts as an expansion to the amount of data being searched, allowing for improved accuracy in searches. In some configurations, a portion of previously generated metadata can be replaced by the AI-generated metadata. Because the system can automatically perform the Al analysis of the training content, maintaining the index of the training content can also be automated. The index of training content is a database of terms, keywords, references, topics, domains, titles, speakers, or any other information about the training content stored within the system. By comparing the index of training content to a user's search, the system can identify where (i.e., in which courses, or portions of courses) desired content is located. Instead of requiring human beings to review the training content, generate keywords/accurate titles, and otherwise manage the index of training courses, the system can now do these processes automatically.

Training course content (also known as course content, or training content), as disclosed herein, can take the form of video with or without an audio track, an audio track by itself, slides, articles, papers, and/or any combination thereof. A piece of training course content can refer to: a single course (e.g., a video course on sexual harassment, or an article on forklift driving); a portion of a single course (e.g., a specific number of slides within a slide-based course, a specific page or specific pages in an article based course, or a specific portion of a video course); and/or one or more questions from an exam portion of a course.

Consider the following example, where a user is searching for training content discussing a specific aspect of the United States Code of Federal Regulations (CFR). CFR content is organized by titles, chapters, parts, etc., such that a given CFR citation may read “17 CFR 240.1” (which happens to be a federal rule associated with the Securities and Exchange (SEC) commission). Prior to the system disclosed herein, if a piece of current training content has not been manually evaluated to determine if that specific CFR section is discussed or otherwise referenced, and metadata created to note that the CFR section is present in a specific piece of content, the user would not be able to search for that content.

Instead, continuing with the example, the system disclosed herein uses Al to extract data out of videos or other course content, perform industry-specific term extraction on the exacted data, and identify that the specific codes of federal regulation referred to within a course. In addition, the system can identify the specific timestamps (in the case of videos) or locations (in the case of slides or articles) of the content. The result is that the user can then execute a search for terms in the training content which have not been manually identified by human beings, and the system can identify the exact locations, by timestamp or other location, where the content is found in the training catalog (that is, the training catalog is the combination of available training courses). As part of the normalization process, the data is saved in a vector database that links phrases to timestamps, page data, or page numbers within the course. Thus, the resulting index is the compilation of those links within the vector database. In some configurations, a given user may only have access to a portion of the training catalog (e.g., the user's job title does not grant them access to a certain training, or the training has certain prerequisites). In such configurations, the system may search only the portion to which the user has access. Alternatively, the system may search an entirety of the catalog, but only provide suggestions to courses for which the user has access.

Consider another example, where a user is searching for laws and regulations for a specific jurisdiction regarding sexual harassment. Every state (or other jurisdiction) will have distinct laws and regulations. The system can use named entity recognition to identify what states or governing authorities are represented within a particular course, thereby identifying the specific courses which would provide the user with the rules and regulations for the desired jurisdiction.

The Al analysis creates a large amount of data, which is normalized. While the normalized data can be used for multiple purposes, in the context of the system disclosed herein it is used to create a search index. A natural language interface can be provided to search that search index, allowing a user to have a conversation with the catalog of available courses and find recommended courses.

In some configurations, the system may allow users to obtain training from a specific portion, or identify answers to specific questions, without being required to take an entire course from beginning to end. To this end, with the known locations of the desired content, the system can select a specific portion of the training course for the user to review. For example, in the case of a training video, the user may need to only watch the portion of the video immediately preceding and following known instances of the subject matter. In the case of an article, the user may need only to be pointed to the exact paragraph where the sought-after subject matter is found.

The system disclosed herein represents a technological improvement to the way online courses are stored, improved, and used. Whereas course content in previous contexts is very inefficient in terms of asking questions and performing searches, systems configured as disclosed herein provide the best of both worlds. That is, in addition to presenting individual learning courses according to traditional and standards-driven methods, the content is further augmented with a low-latency ability to provide transcriptions, questions, summaries, and/or other options.

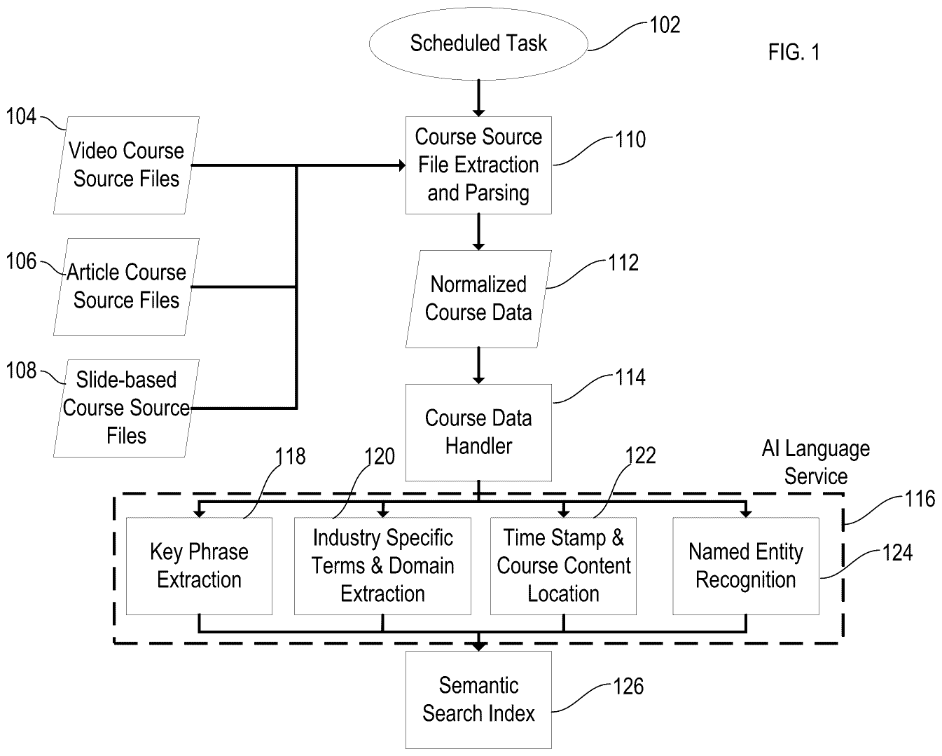

FIG. 1 illustrates an example of course catalog AI index processing. As illustrated, there is a scheduled task 102 programmed to find all of available courses within a catalog and look for change. A scheduled task 102 can, for example, be a task scheduled to occur periodically (e.g., daily, weekly, hourly, etc.). During execution, this periodic, scheduled task 102 looks for new courses, or courses which have been updated. If, for example, a course has been previously analyzed (e.g., the data within the course file was already examined, extracted, and the system index updated with the course data) it would not need to be analyzed again until a change to the course is made. Thus, only a new course being added to the catalog, and/or a course that has received an update, needs to be analyzed. As illustrated, the available courses which the system can search can include video course source files 104, article course source files 106, and slide-based course source files 108.

Upon identifying courses that are new and/or updated, the system extracts and parses 110 the data with those courses according to the scheduled task 102 (as stated above, this can be according to any schedule, preferably this is done periodically, such as daily). During the extraction and parsing 110 the system identifies to which of the three groups-video course files 104, article course files 106, and slide-based course files 108-then updated or new data belongs, extracts the data and parses it. For example, the system will identify new/updated data for a course, then identify that the course is a video course. The system will then use video processing algorithms to further analyze the course and its content. Likewise, if the course were an article-based course, the system would use article processing algorithms, and if the course were a slide-based course the system would use slide processing algorithms. Because these are courses (not just videos, articles, or slides by themselves), there may be exam pools associated with each updated or new course, and the system can extract information from those exam pools. If any pre-existing, human-created metadata (e.g., traditional metadata, such as title, description, keywords, etc.) has already been generated and associated with a course, that pre-generated metadata can also be extracted.

Upon extracting data from the courses and parsing it (e.g., breaking the extracted data down into individual parts/components), the extracted data is normalized into normalized course data 112. Normalizing course data entails organizing the extracted course data into common types of data, including but not limited to audio data, text data, video data, etc. A course data handler 114 then causes, for each appropriate type of data, one or more AI language service 116 algorithms to be executed on the normalized course data 112. Non-limiting examples of these AI language service 116 algorithms can include key phrase extraction 118, industry specific terms and domain extraction 120, time stamp and course content location 122, and/or named entity recognition 124. Each of these AI algorithms can produce data, and in some configurations can work together, to result in extracted data. For example, the key phrases identified by the key phrase extraction 118 algorithm may also be time stamped, such that when key phrases are identified by future searches as being relevant, the associated time stamps can be provided. The illustrated AI algorithms can be run in parallel AI processes, or in other configurations can be run in series. The identified and extracted by these AI language service 116 algorithms can then be added (e.g., via a user interface, allowing the users to add this data in parallel to universal resources constantly available) to a semantic search index 126, such that in the future when a user generates a natural language query, the extracted data can be used to identify the specific content sought after by the user. When determining what content to recommend, the system can first generate a confidence score and associated/configurable thresholds which can be used to filter out results that fall below those thresholds. Next, different libraries can hold more weight than others as such can be prioritized in results. In addition, there can be manually maintained preferences that are considered and used for ranking for results. This combination of filters, available libraries, and manual preferences can result in a user-specific, tailored recommendation algorithm.

The normalized course data 112 can be stored in a vector database, where the data is formatted, stored, and queried in a completely different manner than the original source material 104, 106, 108. The AI language service 116 uses this normalized course data 112 to answer prompts with natural language and references to source material. When users interface with the system based on recommendations of the semantic search index 126, the users can be directed back to the original source material 104, 106, 108. This allows for an efficient query, while also allowing users access to the source materials 104, 106, 108.

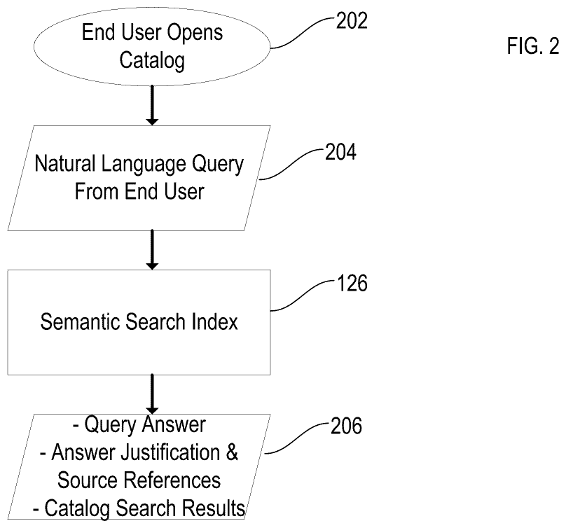

FIG. 2 illustrates an example of a catalog search. In this example, an end user opens a catalog 202 of training courses, and generates a natural language query 204 to search for a desired course. For example, the user can be looking for a course on sexual harassment in Delaware, the system will use the natural language query 204 to search the semantic search index 126, and the system will identify recommended courses found in the catalog that address that question. The query results 206 are a payload (e.g., one or more) of answers with justification for the search results, references to the course catalog, and/or traditional course catalog search results. In some configurations, the system can be configured to provide alternative answers depending on the user's access. For example, an administrator may want to look at the system to determine what courses are going to answer a particular type of problem, where an end user/learner may be wanting to get direct answers.

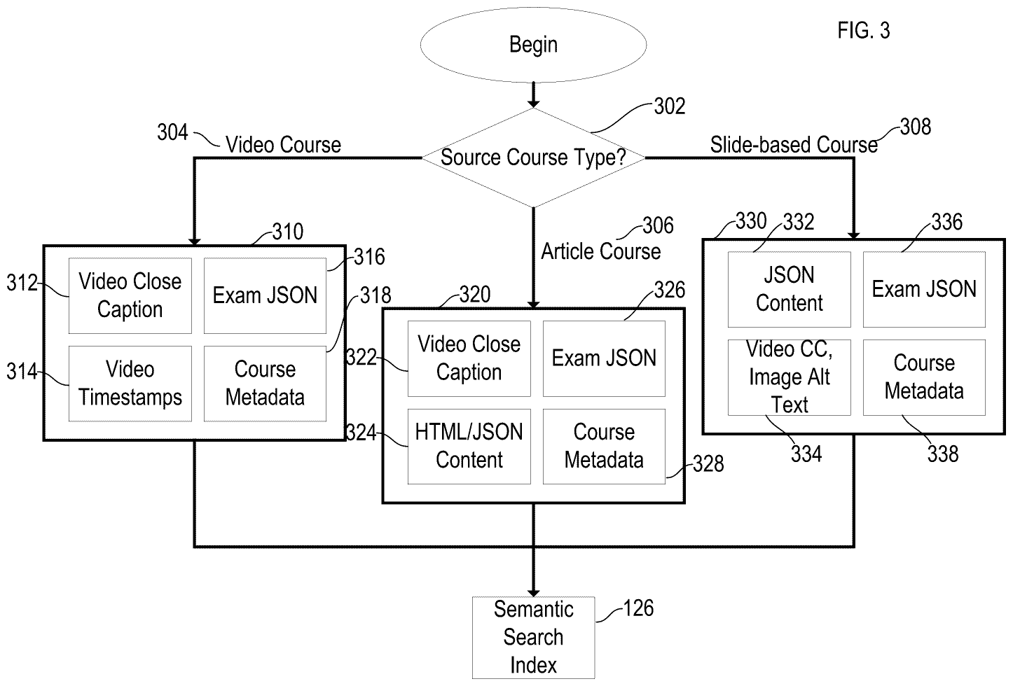

FIG. 3 illustrates an example of course source file extraction and parsing, and represents an expanded view of the extraction and parsing 110 of FIG. 1. As illustrated, upon receiving course content the system determines what type of course content is received 302. As illustrated, three types of course content are present, though in other configurations the course content may include more (or fewer) types of course content. The three types of course content are a video course content 304 (where the course content is presented, at least partially, as a video); an article course content 306 (where the course content is presented, at least partially, as an article); and a slide-based course content 308 (where the course content is presented, at least partially, as a slide-based course). In some instances, a course may have more than one of these course types, in which case the system can segment or otherwise divide the course content into the different types of course content present.

Each of the course types then undergo data extraction and parsing based on the type of course content. Video course content 304 undergoes video course extraction/parsing algorithms 310; Article course content 306 undergoes article course extraction/parsing algorithms 320; and Slide-based course content 308 undergoes slide-based course extraction/parsing algorithms 330. In some instances, the same algorithms can be used across content-types, whereas in other instances individual algorithms, while producing the same end results, may vary based on the type of content being analyzed.

Non-limiting, exemplary video course extraction/parsing algorithms 310 can include: (1) Video close caption analysis 312, where the close captioning of a video is analyzed to identify keywords, which are extracted. If the video does not include closed captioning data, in some configurations the system can perform closed captioning analysis on the audio of the video to produce closed captioning text, then perform keyword extraction from the resulting text. (2) Video timestamp analysis 314 identifying where in the video specific content is found. (3) Exam question analysis 316, where the system can review the exam questions which accompany the video content, identifying and extracting relevant exam data (in a format such as, but not limited to, JavaScript Object Notation (JSON)). And (4) Course metadata analysis 318, where the system can review previously generated course metadata, such as (but not limited to) course title, known topics, hashtags, speakers, author, etc.

Non-limiting, exemplary article course extraction/parsing algorithms 320 can include: (1) Video close caption 322, where the text of the article is analyzed in a manner similar to the closed captioning of a video. (2) Analysis of Hyper-Text Markup Language (HTML)/JSON content 324, where some or all text of the text of the article is found in an HTML/JSON format. (3) Exam question analysis 326, where the system can review the exam questions which accompany the video content, identifying and extracting relevant exam data (in a format such as, but not limited to, JSON. And (4) Course metadata analysis 328, where the system can review previously generated course metadata, such as (but not limited to) course title, known topics, hashtags, speakers, author, etc.

Non-limiting, exemplary slide-based course extraction/parsing algorithms 330 can include: (1) JSON content analysis 332, where some or all text of the text of the article is found in an JSON format. (2) Analysis of video closed captioning, or image alternative text 334 contained within the slides. (3) Exam question analysis 336, where the system can review the exam questions which accompany the video content, identifying and extracting relevant exam data (in a format such as, but not limited to, JSON. And (4) Course metadata analysis 338, where the system can review previously generated course metadata, such as (but not limited to) course title, known topics, hashtags, speakers, author, etc.

Upon extracting and parsing the data from one or more of the video course extraction/parsing algorithms 310, the article course extraction/parsing algorithms 320, and/or the slide-based course extraction/parsing algorithms 330, the system organizes the extracted data into the semantic search index 126, for further use as shown in FIG. 2.

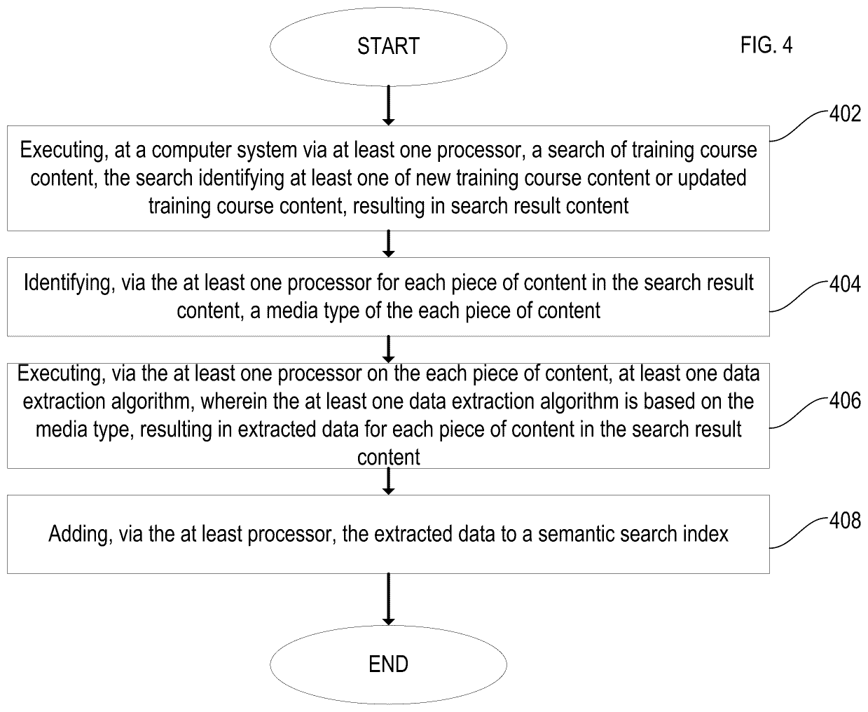

FIG. 4 illustrates an example method embodiment. As illustrated, execution of the method can include: executing, at a computer system via at least one processor, a search of training course content stored in a database, the search identifying at least one of new training course content or updated training course content, resulting in search result content (402). Next, the method involves identifying, via the at least one processor for each piece of content in the search result content, a media type of the each piece of content (404) and executing, via the at least one processor on the each piece of content, at least one data extraction algorithm, wherein the at least one data extraction algorithm is based on the media type, resulting in extracted data for each piece of content in the search result content (406). The illustrated method then concludes by adding, via the at least processor, the extracted data to a semantic search index (408).

In some configurations, the illustrated method can further include receiving, at the computer system, a natural language query from a user; searching, via the at least one processor, the semantic search index for a response to the natural language query, resulting in query search results; and displaying, via a display of the computer system, the query search results in response to the natural language query. In such configurations, the query search results can include at least one source for each query search result in the query search results.

In some configurations, the training course content can further include a plurality of courses, with each course in the plurality of courses comprising training content and exam questions. In such configurations, the training content can further include at least one of video

In some configurations, the at least one data extraction algorithm can include at least one Artificial Intelligence (AI) language service. Non-limiting examples of an AI language service can include: key phrase extraction; recognition of named entities; and domain extraction.

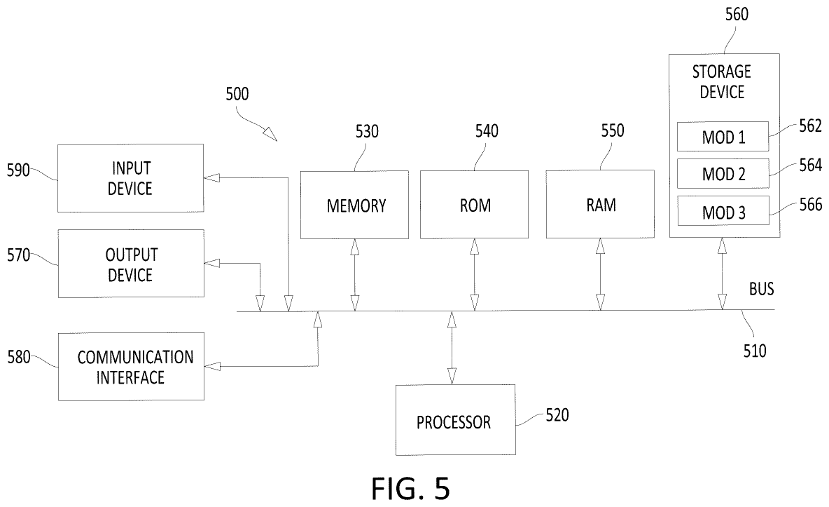

With reference to FIG. 5, an exemplary system includes a computing device 500 (such as a general-purpose computing device), including a processing unit (CPU or processor) 520 and a system bus 510 that couples various system components including the system memory 530 such as read-only memory (ROM) 540 and random access memory (RAM) 550 to the processor 520. The computing device 500 can include a cache of high-speed memory connected directly with, in close proximity to, or integrated as part of the processor 520. The computing device 500 copies data from the system memory 530 and/or the storage device 560 to the cache for quick access by the processor 520. In this way, the cache provides a performance boost that avoids processor 520 delays while waiting for data. These and other modules can control or be configured to control the processor 520 to perform various actions. Other system memory 530 may be available for use as well. The system memory 530 can include multiple different types of memory with different performance characteristics. It can be appreciated that the disclosure may operate on a computing device 500 with more than one processor 520 or on a group or cluster of computing devices networked together to provide greater processing capability. The processor 520 can include any general-purpose processor and a hardware module or software module, such as module 1 562, module 2 564, and module 3 566 stored in storage device 560, configured to control the processor 520 as well as a special-purpose processor where software instructions are incorporated into the actual processor design. The processor 520 may essentially be a completely self-contained computing system, containing multiple cores or processors, a bus, memory controller, cache, etc. A multi-core processor may be symmetric or asymmetric.

The system bus 510 may be any of several types of bus structures including a memory bus or memory controller, a peripheral bus, and a local bus using any of a variety of bus architectures. A basic input/output (BIOS) stored in memory ROM 540 or the like, may provide the basic routine that helps to transfer information between elements within the computing device 500, such as during start-up. The computing device 500 further includes storage devices 560 such as a hard disk drive, a magnetic disk drive, an optical disk drive, tape drive or the like. The storage device 560 can include software modules 562, 564, 566 for controlling the processor 520. Other hardware or software modules are contemplated. The storage device 560 is connected to the system bus 510 by a drive interface. The drives and the associated computer-readable storage media provide nonvolatile storage of computer-readable instructions, data structures, program modules and other data for the computing device 500. In one aspect, a hardware module that performs a particular function includes the software component stored in a tangible computer-readable storage medium in connection with the necessary hardware components, such as the processor 520, system bus 510, output device 570 (such as a display or speaker), and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the computing device 500 is a small, handheld computing device, a desktop computer, or a computer server.

Although the exemplary embodiment described herein employs the storage device 560 (such as a hard disk), other types of computer-readable media which can store data that are accessible by a computer, such as magnetic cassettes, flash memory cards, digital versatile disks, cartridges, random access memories (RAMs) 550, and read-only memory (ROM) 540, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 500, an input device 590 represents any number of input mechanisms, such as a microphone for speech, a touch-sensitive screen for gesture or graphical input, keyboard, mouse, motion input, speech and so forth. An output device 570 can also be one or more of a number of output mechanisms known to those of skill in the art. In some instances, multimodal systems enable a user to provide multiple types of input to communicate with the computing device 500. The communications interface 580 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

In one embodiment, using AI to process the entire course into a normalized search index, an online training catalog can be a much more effective tool in recording the right training, case the burden of index maintenance, and provide alternative paths to learning objectives. Having access to Al generated keywords, phrases, industry terms, and named entities generated directly from source content (including: course text, video closed captions, images, image alt text, learning objectives, regulatory references, human-generated course metadata, and course structure), a search can be much more effective in selecting the right course. An AI can return results with much more confidence and provide in-context reasoning for training selections. Since all searchable terms are AI generated via a scheduled workflow, new courses and course updates can be instantly represented in the most effective way possible. The combination of Natural Language Query and AI indexing as disclosed herein can also allow for natural language responses as part of the results. Search results provide answers to the query and references to the online course content the answer was extracted from. This allows the learner or training administrator to gain knowledge from a trusted source, understand the course on a much deeper level, and still have access to traditional search results.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A method comprising: executing, at a computer system via at least one processor, a search of training course content stored in a database, the search identifying at least one of new training course content or updated training course content, resulting in search result content; identifying, via the at least one processor for each piece of content in the search result content, a media type of the each piece of content; executing, via the at least one processor on the each piece of content, at least one data extraction algorithm, wherein the at least one data extraction algorithm is based on the media type, resulting in extracted data for each piece of content in the search result content; and adding, via the at least processor, the extracted data to a semantic search index.

The method of any preceding clause, further comprising: receiving, at the computer system, a natural language query from a user; searching, via the at least one processor, the semantic search index for a response to the natural language query, resulting in query search results; and displaying, via a display of the computer system, the query search results in response to the natural language query.

The method of any preceding clause, wherein the query search results further comprise at least one source for each query search result in the query search results.

The method of any preceding clause, wherein the training course content further comprises a plurality of courses, with each course in the plurality of courses comprising training content and exam questions.

The method of any preceding clause, wherein the training content comprises at least one of video course content, slide-based course content, and article course content.

The method of any preceding clause, wherein the at least one data extraction algorithm comprises at least one Artificial Intelligence (AI) language service.

The method of any preceding clause, wherein the at least one Al language service comprises: key phrase extraction; recognition of named entities; and domain extraction.

A system comprising: at least one processor; and a non-transitory computer-readable storage medium having instructions stored which, when executed by the at least one processor, cause the at least one processor to perform operations comprising: executing a search of training course content stored in a database, the search identifying at least one of new training course content or updated training course content, resulting in search result content; identifying, for each piece of content in the search result content, a media type of the each piece of content; executing, on the each piece of content, at least one data extraction algorithm, wherein the at least one data extraction algorithm is based on the media type, resulting in extracted data for each piece of content in the search result content; and adding the extracted data to a semantic search index.

The system of any preceding clause, the non-transitory computer-readable storage medium having additional instructions stored which, when executed by the at least one processor, cause the at least one processor to perform operations comprising: receiving a natural language query from a user; searching the semantic search index for a response to the natural language query, resulting in query search results; and displaying, via a display of the system, the query search results in response to the natural language query.

The system of any preceding clause, wherein the query search results further comprise at least one source for each query search result in the query search results.

The system of any preceding clause, wherein the training course content further comprises a plurality of courses, with each course in the plurality of courses comprising training content and exam questions.

The system of any preceding clause, wherein the training content comprises at least one of video course content, slide-based course content, and article course content.

The system of any preceding clause, wherein the at least one data extraction algorithm comprises at least one Artificial Intelligence (AI) language service.

The system of any preceding clause, wherein the at least one AI language service comprises: key phrase extraction; recognition of named entities; and domain extraction.

A non-transitory computer-readable storage medium having instructions stored which, when executed by at least one processor, cause the at least one processor to perform operations comprising: executing a search of training course content stored in a database, the search identifying at least one of new training course content or updated training course content, resulting in search result content; identifying, for each piece of content in the search result content, a media type of the each piece of content; executing, on the each piece of content, at least one data extraction algorithm, wherein the at least one data extraction algorithm is based on the media type, resulting in extracted data for each piece of content in the search result content; and adding the extracted data to a semantic search index.

The non-transitory computer-readable storage medium of any preceding clause, having additional instructions stored which, when executed by the at least one processor, cause the at least one processor to perform operations comprising: receiving a natural language query from a user; searching the semantic search index for a response to the natural language query, resulting in query search results; and displaying, via a display, the query search results in response to the natural language query.

The non-transitory computer-readable storage medium of any preceding clause, wherein the query search results further comprise at least one source for each query search result in the query search results.

The non-transitory computer-readable storage medium of any preceding clause, wherein the training course content further comprises a plurality of courses, with each course in the plurality of courses comprising training content and exam questions.

The non-transitory computer-readable storage medium of any preceding clause, wherein the training content comprises at least one of video course content, slide-based course content, and article course content.

The non-transitory computer-readable storage medium of any preceding clause, wherein the at least one data extraction algorithm comprises at least one Artificial Intelligence (AI) language service.

We claim:

1. A method comprising:
executing, at a computer system via at least one processor, a search of training course content stored in a database, the search identifying at least one of new training course content or updated training course content, resulting in search result content;
identifying, via the at least one processor for each piece of content in the search result content, a media type of the each piece of content;
executing, via the at least one processor on the each piece of content, at least one data extraction algorithm, wherein the at least one data extraction algorithm is based on the media type, resulting in extracted data for each piece of content in the search result content; and
adding, via the at least one processor, the extracted data to a semantic search index.

2. The method of claim 1, further comprising:
receiving, at the computer system, a natural language query from a user;
searching, via the at least one processor, the semantic search index for a response to the natural language query, resulting in query search results; and
displaying, via a display of the computer system, the query search results in response to the natural language query.

3. The method of claim 2, wherein the query search results further comprise at least one source for each query search result in the query search results.

4. The method of claim 1, wherein the training course content further comprises a plurality of courses, with each course in the plurality of courses comprising training content and exam questions.

5. The method of claim 4, wherein the training content comprises at least one of video course content, slide-based course content, and article course content.

6. The method of claim 1, wherein the at least one data extraction algorithm comprises at least one Artificial Intelligence (AI) language service.

7. The method of claim 6, wherein the at least one AI language service comprises:
key phrase extraction;
recognition of named entities; and
domain extraction.

8. A system comprising:
at least one processor; and
a non-transitory computer-readable storage medium having instructions stored which, when executed by the at least one processor, cause the at least one processor to perform operations comprising:
executing a search of training course content stored in a database, the search identifying at least one of new training course content or updated training course content, resulting in search result content;
identifying, for each piece of content in the search result content, a media type of the each piece of content;
executing, on the each piece of content, at least one data extraction algorithm,
wherein the at least one data extraction algorithm is based on the media type, resulting in extracted data for each piece of content in the search result content; and
adding the extracted data to a semantic search index.

9. The system of claim 8, the non-transitory computer-readable storage medium having additional instructions stored which, when executed by the at least one processor, cause the at least one processor to perform operations comprising:
receiving a natural language query from a user;
searching the semantic search index for a response to the natural language query, resulting in query search results; and
displaying, via a display of the system, the query search results in response to the natural language query.

10. The system of claim 9, wherein the query search results further comprise at least one source for each query search result in the query search results.

11. The system of claim 8, wherein the training course content further comprises a plurality of courses, with each course in the plurality of courses comprising training content and exam questions.

12. The system of claim 11, wherein the training content comprises at least one of video course content, slide-based course content, and article course content.

13. The system of claim 8, wherein the at least one data extraction algorithm comprises at least one Artificial Intelligence (AI) language service.

14. The system of claim 13, wherein the at least one AI language service comprises:
key phrase extraction;
recognition of named entities; and
domain extraction.

15. A non-transitory computer-readable storage medium having instructions stored which, when executed by at least one processor, cause the at least one processor to perform operations comprising:
executing a search of training course content stored in a database, the search identifying at least one of new training course content or updated training course content, resulting in search result content;
identifying, for each piece of content in the search result content, a media type of the each piece of content;
executing, on the each piece of content, at least one data extraction algorithm, wherein the at least one data extraction algorithm is based on the media type, resulting in extracted data for each piece of content in the search result content; and
adding the extracted data to a semantic search index.

16. The non-transitory computer-readable storage medium of claim 15, having additional instructions stored which, when executed by the at least one processor, cause the at least one processor to perform operations comprising:
receiving a natural language query from a user;
searching the semantic search index for a response to the natural language query, resulting in query search results; and
displaying, via a display, the query search results in response to the natural language query.

17. The non-transitory computer-readable storage medium of claim 16, wherein the query search results further comprise at least one source for each query search result in the query search results.

18. The non-transitory computer-readable storage medium of claim 15, wherein the training course content further comprises a plurality of courses, with each course in the plurality of courses comprising training content and exam questions.

19. The non-transitory computer-readable storage medium of claim 18, wherein the training content comprises at least one of video course content, slide-based course content, and article course content.

20. The non-transitory computer-readable storage medium of claim 15, wherein the at least one data extraction algorithm comprises at least one Artificial Intelligence (AI) language service.
